(19) United States
(12) Patent Application Publication
(10) Pub. No.: US 2010/0083383 A1
(43) Pub. Date: Apr. 1, 2010

(54) PHISHING SHIELD

(75) Inventors: Darin B. Adler, Los Gatos, CA (US); Kevin Decker, San Jose, CA (US)

Correspondence Address: APPLE INC./BSTZ;BLAKELY SOKOLOFF TAYLOR & ZAFMAN LLP, 1279 OAKMEAD PARKWAY, SUNNYVALE, CA, 94085-4040, US

(73) Assignee: Apple Inc., Cupertino, CA (US)

(21) Appl. No.: 12/242,717

(22) Filed: Sep. 30, 2008

(51) Int. Cl. G06F 21/00

(52) U.S. Cl. 726/26

(57) ABSTRACT

A mechanism for notifying a user of an internet browser that a requested web page is undesirable, and for protecting the user from the web page by disabling it. An internet browser detects a load request for a web page and retrieves the Uniform Resource Locator (URL) for the webpage. The internet browser displays the webpage associated with the URL and, upon determination that the URL matches a URL from a list of undesirable URLs, alters the appearance of the webpage and disables the web page from receiving input or taking action.

### FIELD OF THE INVENTION

Embodiments relate generally to the field of internet browsing. More particularly, embodiments relate to a method and a system for notifying a user of an internet browser that a requested website is a forgery, and protecting the user from the forged website.

### BACKGROUND OF THE INVENTION

One of the most important and common functions of modern personal computers is providing access to and presenting internet content. Internet content is typically provided and presented to users by means of an internet browser, such as SAFARI® made by APPLE® Inc., of Cupertino, Calif. or FIREFOX® made by MOZILLA® Corp., of Mountain View, Calif. or INTERNET EXPLORER® made by MICROSOFT® Corp., of Redmond, Wash.

As internet use has become more common, many businesses have begun to use the internet as a medium through which to interact with customers, both new and existing. Such businesses include existing businesses, such as those providing financial services, seeking to augment services already provided through other means, as well as new businesses established to provide services solely through the internet.

Many of these businesses require customers to provide sensitive or private personal information through a web page in order to gain access to services. Such sensitive personal information may include social security information, address and telephone number, birth date, credit card information, etc. There also exist other types of non-commercial websites that request similarly sensitive personal information.

As the use of such websites has become more common, so has the practice of creating forged replicas of the websites as a means of obtaining sensitive personal information from unsuspecting or less than savvy internet users. The use of forged replicas of websites to obtain sensitive personal information is known in the art as “phishing.” Phishing is typically used to obtain personal or financial information in order to enable identity theft or other fraudulent or disreputable activities.

As concern over phishing has grown, developers of internet browsers have attempted to protect users from the practice. One means of protecting users from phishing involves the use of a repository of IP address ranges known to be suspect, made available at a trusted internet location. Internet browsers are often equipped with a means for comparing requested websites with such repositories, and will provide some indicator to users if a requested website is suspected to be a forgery.

### SUMMARY OF THE DESCRIPTION

A mechanism for notifying a user of an internet browser that a requested web page is undesirable, and for protecting the user from the web page by disabling it is described herein. In various embodiment, an internet browser detects a load request for a web page and retrieves the Uniform Resource Locator (URL) for the webpage. The internet browser displays the webpage associated with the URL and, upon determination that the URL matches a URL from a list of undesirable URLs, alters the appearance of the webpage and disables the web page from receiving input or taking action.

### BRIEF DESCRIPTION OF THE DRAWINGS

The embodiments of the present invention are illustrated by way of example and not limitation in the figures of the accompanying drawings, in which like references indicate similar elements and in which:

FIG. 1A illustrates a webpage requesting information from the user;

FIG. 1B illustrates a webpage requesting information from the user, wherein the webpage has been disabled and the user is being notified of a suspected forgery, according to one embodiment of the invention.

FIG. 2 is a block diagram of one embodiment of a mechanism for determining whether a requested webpage is a forgery.

FIG. 3 is a flow diagram of one embodiment of a method for detecting whether a requested webpage is a forgery, and disabling the webpage if the webpage is a forgery.

FIG. 4 is a block diagram of a computing device on which embodiments of the invention may be implemented.

### DETAILED DESCRIPTION

In the following description, numerous details are set forth. It will be apparent, however, to one skilled in the art, that the present invention may be practiced without these specific details. In some instances, well-known structures and devices are shown in block diagram form, rather than in detail, in order to avoid obscuring the present invention.

In general, the embodiments described below describe methods and systems for disabling a requested web page and altering the appearance of the web page, when the web page is determined to be undesirable, for example, because it is suspected of being a forgery. When a webpage is determined to be a suspected forgery, it is disabled and altered in appearance, perhaps substantially, in order to communicate to the user that the webpage is likely to be fraudulent.

In some embodiments, detection of a forged webpage is performed by use of a blacklist, or a list of suspicious IP addresses, provided at a trusted location. The trusted location is a repository with a current list of IP addresses associated with suspicious activity. In some embodiments, the trusted location may be a service provided by a third party, such as Google, Inc., of Mountain View, Calif., or Symantec Corp., of Cupertino, Calif.

Additionally, a list of known trusted host names and/or IP addresses may be maintained in the web browser or in a data processing system that communicates with the web browser. The trusted host names may initially be “seeded” by the manufacturer of the web browser or data processing system or may be additionally or alternatively “seeded” by the user's importing of bookmarks or favorites from previously used web browsers or systems into a new web browser or data processing system. In certain embodiments, the user may build on this list of trusted host names every time they type a URL by hand or follow a link from a trusted page, or, more rarely, by indicating explicitly that a web site is to be trusted when prompted by the data processing system or web browser for a decision about whether to trust the website. In other words, any URL hand typed by a user (or link followed from a trusted page or otherwise explicitly acknowledged by the user) is added to the list of trusted host names, IP addresses, and/or websites. Thus, in addition to determining whether a website is fraudulent, the website in question may be compared against a list of suspicious sites or it may be compared against a list of trusted sites to determine its authenticity.

Such features improve on the existing anti-phishing art by actively protecting a user from a suspected forgery. The prior art in anti-phishing measures passively notify the user of a suspected forgery, but does nothing to prevent a user from interacting with the webpage. Often, the notification is an icon in a toolbar, or a small dialog element that a user can quickly dismiss. Indeed, to an unsophisticated user, the prior art is not sufficient protection, because such a user often ignores warning dialogs, and is unaware of the danger of phishing.

At least certain embodiments of the invention, when implemented as an anti-phishing protection, take an active approach to combat phishing. Altering the appearance of a webpage presents a more distinct indicator to the user than a generic warning dialog. In one embodiment, a graphical element resembling a translucent shield indicates that measures are being taken to protect the user. Furthermore, where embodiments of the invention use a warning dialog, the dialog is merely informative of why the webpage is disabled, such that a user cannot simply dismiss it and thereby access the undesirable page. Rather, a user is required to take a more deliberate action to bypass the protections.

Another element of the invention's active approach involves disabling the webpage determined to be undesirable. In some embodiments, disabling a webpage includes disabling graphical interface elements that accept user input, as well as scripting elements of the webpage, which are often used by phishing websites for fraudulent purposes.

Alternative embodiments of the invention alter and disable web pages determined to be undesirable for reasons other than being suspected forgeries. For example, one embodiment of the invention would implement a parental control that allows one user of the internet browser to restrict the websites accessible to other users. Yet another embodiment might allow employers to restrict websites accessible by employees via internet browsers on computers intended only for business-related use.

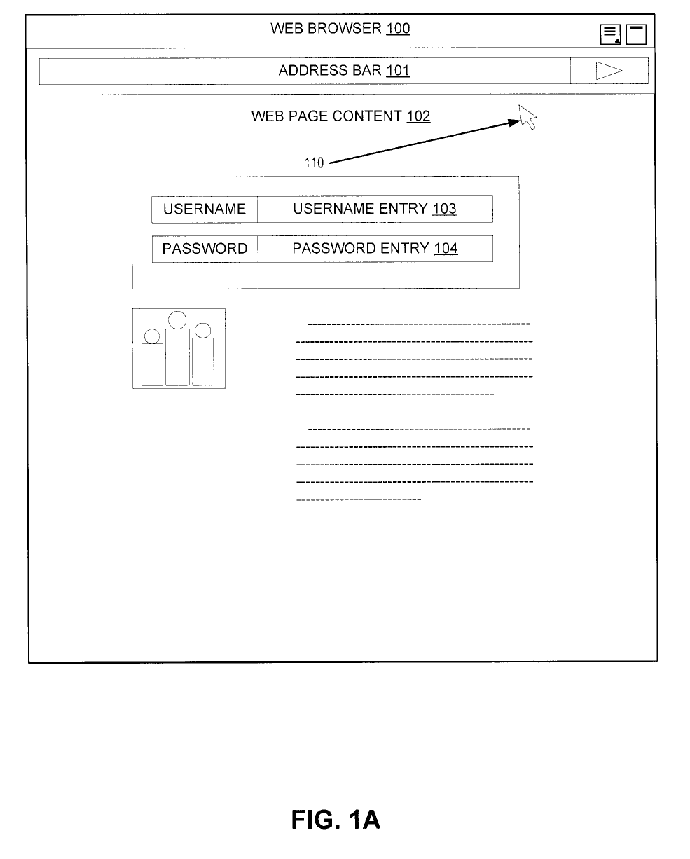

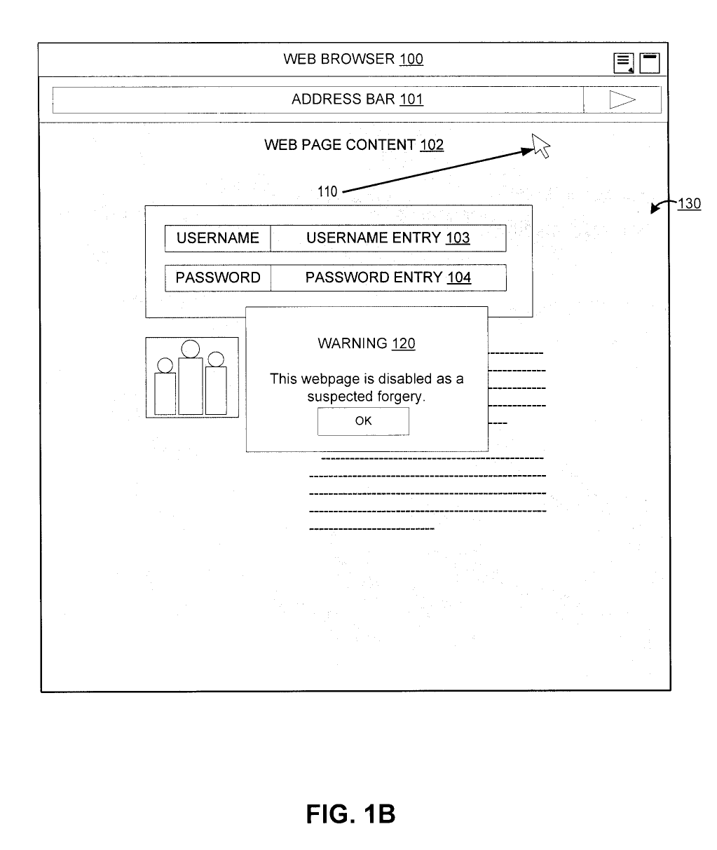

FIG. 1A illustrates an example of a webpage requesting information from a user. Web browser 100 is displaying content 102 for a requested webpage identified by the Uniform Resource Locator (URL) in address bar 101. The webpage requests a user to enter a username in the username entry field 103 and a password in the password entry field 104.

FIG. 1B illustrates the same example webpage from FIG. 1A, as it would appear in one embodiment of the invention, if it were determined to be a suspected forgery. The content 102 is displayed behind a graphical element representing a gray-tinted glass shield, 130 which acts as a translucent shield. This shield 130 may be appear in an animated fashion when activated. For example, the shield may appear by sliding down from the top of web browser 100, slidind up from the bottom, sliding in from one side or another, fading in and out, or by any other means known in the art. Username entry field 103 and password entry field 104 are disabled. Warning 120 is what is known in the art as a modal dialog box, requiring the user to acknowledge the warning before the user can interact any further with the internet browser.

However, the warning displayed in element 120 does not, when dismissed, also dismiss the anti-phishing protections altering the appearance of content 102 or disabling the username entry field 103 and password entry field 104. The warning simply alerts the user as to why the protections have been activated. A user would have to perform some additional action in certain embodiments, such as navigating to a menu item, or selecting a toolbar icon, to disable these protections, thus preventing a user from hastily dismissing the protections.

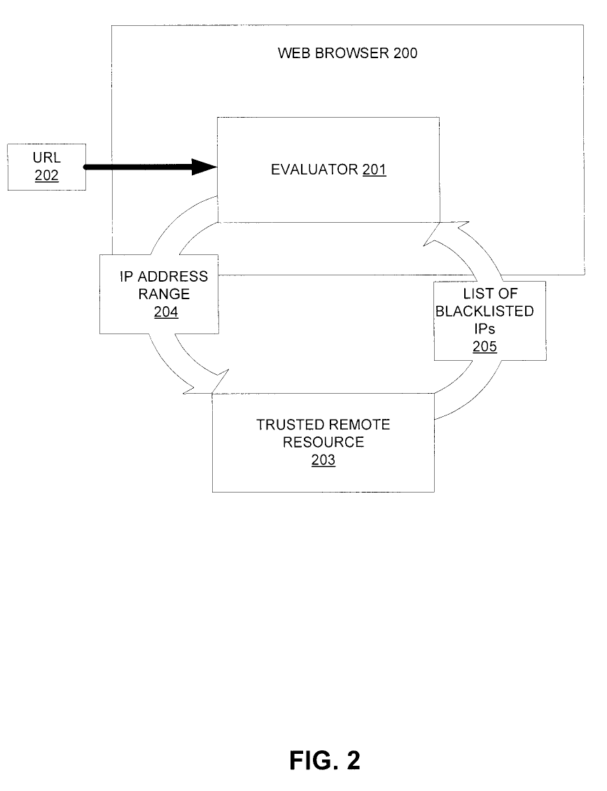

FIG. 2 illustrates an implementation of determining whether a requested URL is a forgery. Web browser 200 receives, at evaluator 201, a request for URL 202. Evaluator 201 sends an IP address range 204, containing the IP associated with the requested URL 202, to a trusted remote resource 203. The address range may simply be a partial IP address obtained by dropping a fixed number of bits from the IP associated with the requested URL 202. The trusted resource responds to the IP address range 204 with a list of blacklisted IP addresses, 205, containing all suspicious IP addresses in the requested range 204. The evaluator 201 then searches this list of suspicious IP addresses 205 for the IP address associated with the requested URL 202. If the IP address is found then the requested URL 202 has been determined to be a suspected forgery. Otherwise, the requested URL 202 has been determined not to be a suspected forgery. In other embodiments, a value obtained by hashing the IP address may be sent, rather than the IP address range. In either alternative, the purpose of this method of using a trusted remote resource is to protect the privacy of the user, so as to prevent any tracking of exactly which URLs the user is requesting.

As discussed above, the trusted remote resource 203 is a repository with a current list of IP addresses associated with suspicious activity. In some embodiments, trusted remote resource 203 may be a service provided by Google, Inc., of Mountain View, Calif., or Symantec Corp., of Cupertino, Calif.

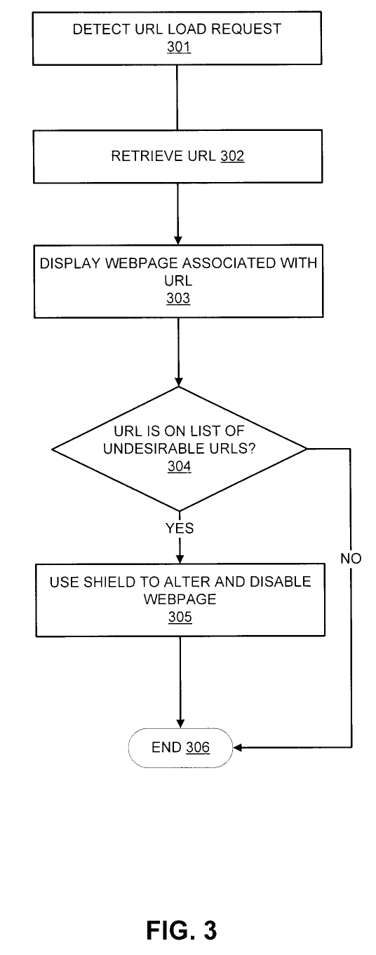

FIG. 3 illustrates a flow diagram of a method for altering the appearance of and disabling a web page when it is determined to be undesirable, according to the implementation illustrated in FIGS. 1A-B. At 301, the method detects a URL load request. The load request may come from user input, or it may come from elsewhere. For example, the load request may also come from an already open webpage that is attempting to load another webpage in a new window, or in the same window by a redirect, which occurs when a particular website, upon loading, directs the internet browser to retrieve a different URL. At 302, the method retrieves the web page at the requested URL. At 303, the method displays the web page retrieved from the requested URL. At 304, the method determines whether the requested URL is on the list of undesirable URLs. If the web page is not on the list, the method completes at 306. Otherwise, the method uses the graphical element resembling the shield to alter and disable the webpage, at 305, before completing at 306.

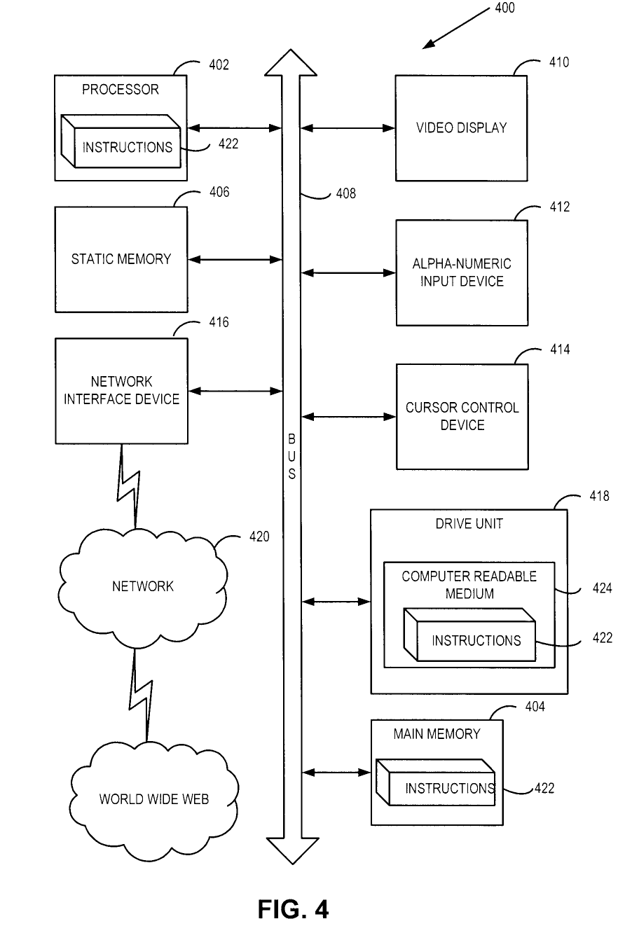

FIG. 4 illustrates a diagrammatic representation of a machine in the exemplary form of a computer system 400 within which a set of instructions, for causing the machine to perform any one or more of the methodologies discussed herein, may be executed. In alternative embodiments, the machine may be connected (e.g., networked) to other machines in a Local Area Network (LAN), an intranet, an extranet, or the Internet. The machine may operate in the capacity of a server or a client machine in a client-server network environment, or as a peer machine in a peer-to-peer (or distributed) network environment. The machine may be a personal computer (PC), a tablet PC, a set-top box (STB), a Personal Digital Assistant (PDA), a cellular telephone, or any machine capable of executing a set of instructions (sequential or otherwise) that specify actions to be taken by that machine. Further, while only a single machine is illustrated, the term “machine” shall also be taken to include any collection of machines (e.g., computers) that individually or jointly execute a set (or multiple sets) of instructions to perform any one or more of the methodologies discussed herein.

The exemplary computer system 400 includes a processor 402, a main memory 404 (e.g., read-only memory (ROM), flash memory, dynamic random access memory (DRAM) such as synchronous DRAM (SDRAM) or Rambus DRAM (RDRAM), etc.), a static memory 406 (e.g., flash memory, static random access memory (SRAM), etc.), and a secondary memory 418 (e.g., a data storage device), which communicate with each other via a bus 408.

Processor 402 represents one or more general-purpose processing devices such as a microprocessor, central processing unit, or the like. More particularly, the processor 402 may be a complex instruction set computing (CISC) microprocessor, reduced instruction set computing (RISC) microprocessor, very long instruction word (VLIW) microprocessor, a processor implementing other instruction sets, or processors implementing a combination of instruction sets. Processor 402 may also be one or more special-purpose processing devices such as an application specific integrated circuit (ASIC), a field programmable gate array (FPGA), a digital signal processor (DSP), network processor, or the like. Processor 402 is configured to execute the processing logic 126 for performing the operations and steps discussed herein.

The computer system 400 may further include a network interface device 416. The computer system 400 also may include a video display unit 410 (e.g., a liquid crystal display (LCD) or a cathode ray tube (CRT)), an alphanumeric input device 412 (e.g., a keyboard), and a cursor control device 414 (e.g., a mouse)

The secondary memory 418 may include a machine-readable storage medium (or more specifically a computer-readable storage medium) 424 on which is stored one or more sets of instructions (e.g., software 422) embodying any one or more of the methodologies or functions described herein. The software 422 may also reside, completely or at least partially, within the main memory 404 and/or within the processing device 402 during execution thereof by the computer system 400, the main memory 404 and the processing device 402 also constituting machine-readable storage media. The software 422 may further be transmitted or received over a network 420 via the network interface device 416.

While the machine-readable storage medium 424 is shown in an exemplary embodiment to be a single medium, the term “machine-readable storage medium” should be taken to include a single medium or multiple media (e.g., a centralized or distributed database, and/or associated caches and servers) that store the one or more sets of instructions. The term “machine-readable storage medium” shall also be taken to include any medium that is capable of storing or encoding a set of instructions for execution by the machine and that cause the machine to perform any one or more of the methodologies of the present invention. The term “machine readable storage medium” shall accordingly be taken to include, but not be limited to, solid-state memories, and optical and magnetic media.

Various operations or functions are described herein, which may be implemented or defined as software code or instructions. Such content may be directly executable (“object” or “executable” form), source code, or difference code (“delta” or “patch” code). Software implementations of the embodiments described herein may be provided via an article of manufacture with the code or instructions stored thereon, or via a method of operating a communication interface to send data via the communication interface. A machine or computer readable storage medium may cause a machine to perform the functions or operations described, and includes any mechanism that stores information in a form accessible by a machine (e.g., computing device, electronic system, etc.), such as recordable/non-recordable media (e.g., read only memory (ROM), random access memory (RAM), magnetic disk storage media, optical storage media, flash memory devices, etc.). A communication interface includes any mechanism that interfaces to any of a hardwired, wireless, optical, etc., medium to communicate to another device, such as a memory bus interface, a processor bus interface, an Internet connection, a disk controller, etc. The communication interface can be configured by providing configuration parameters and/or sending signals to prepare the communication interface to provide a data signal describing the software content. The communication interface can be accessed via one or more commands or signals sent to the communication interface.

The present invention also relates to a system for performing the operations herein. This system may be specially constructed for the required purposes, or it may comprise a general purpose computer selectively activated or reconfigured by a computer program stored in the computer. Such a computer program may be stored in a computer readable storage medium, such as, but not limited to, any type of disk including floppy disks, optical disks, CDROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The methods and displays presented herein are not inherently related to any particular computer or other apparatus. Various general purpose systems may be used with programs in accordance with the teachings herein, or it may prove convenient to construct a more a specialized system to perform the required operations of the method. Structure for a variety of these systems will appear as set forth in the description below. In addition, the present invention is not described with reference to any particular programming language or operating system. It will be appreciated that a variety of programming languages may be used to implement the teachings of the invention as described herein, and the teachings may be implemented within a variety of operating systems.

The operations and functions described herein can be implemented as software modules, hardware modules, special-purpose hardware (e.g., application specific hardware, application specific integrated circuits (ASICs), digital signal processors (DSPs), etc.), embedded controllers, hardwired circuitry, etc.

Aside from what is described herein, various modifications may be made to the disclosed embodiments and implementations of the invention without departing from their scope. Therefore, the illustrations and examples herein should be construed in an illustrative, and not a restrictive sense. The scope of the invention should be measured solely by reference to the claims that follow.

What is claimed is:

1. A method for browsing the internet, comprising:
detecting a load request for a webpage in a web browser;
retrieving a Uniform Resource Locator (URL) for the webpage;
displaying the webpage associated with the URL via the web browser;
determining that the URL matches a URL from a list of undesirable URLs; and
altering the appearance of the webpage and disabling the webpage from receiving input or taking action.

2. The method of claim 1, wherein the webpage appearance is altered by at least one of
overlaying the webpage with a graphical element resembling a glass shield; or
overlaying the webpage with graphical elements resembling cobwebs.

3. The method of claim 1, wherein the webpage is disabled by at least one of
disabling script elements of the webpage;
disabling user input fields on the webpage;
disabling plug-in elements of the webpage;
disabling redirect requests initiated by the webpage;
disabling selectable graphical elements of the webpage; or
disabling the further transfer of data between the webpage and the browser.

4. The method of claim 1, wherein a URL is determined to be undesirable because the URL is known or suspected to be a phishing website that mimics a trusted website in order to obtain confidential user information.

5. The method of claim 1, wherein a URL is determined to be undesirable for reasons including at least one of:
the URL is known to contain pornographic or offensive material; or
the URL is associated with a website that is non-business related.

6. The method of claim 1, wherein the altering and disabling of the webpage is animated.

7. The method of claim 1, wherein a warning is displayed in conjunction with the altering and disabling of the webpage, the warning explaining one or more risks associated with the webpage.

8. The method of claim 1, wherein an option is provided in conjunction with the altering and disabling of the webpage, the option enabling a user to override the altering and disabling of the webpage.

9. An article of manufacture comprising a machine accessible storage medium having content to provide instructions to result in a machine performing operations including:
detecting a load request for a webpage in a web browser;
retrieving a Uniform Resource Locator (URL) for the webpage;
displaying the webpage associated with the URL via the web browser;
determining that the URL matches a URL from a list of undesirable URLs; and
altering the appearance of the webpage and disabling the webpage from receiving input or taking action.

10. An article of manufacture as in claim 9, wherein the instructions to result in a machine altering the webpage appearance include instructions to perform at least one of the following operations
overlaying the webpage with a graphical element resembling a glass shield; or
overlaying the webpage with graphical elements resembling cobwebs.

11. An article of manufacture as in claim 9, wherein the instructions to result in a machine disabling the webpage include instructions to perform at least one of the following operations:
disabling script elements of the webpage;
disabling user input fields on the webpage;
disabling plug-in elements of the webpage;
disabling redirect requests initiated by the webpage;
disabling selectable graphical elements of the webpage; or
disabling the further transfer of data between the webpage and the browser.

12. An article of manufacture as in claim 9, wherein the list of undesirable URLs includes URLs that are undesirable because the URLs are known or suspected to be phishing websites that mimic a trusted website in order to obtain confidential user information.

13. An article of manufacture as in claim 9, wherein the list of undesirable URLs includes URLs that are undesirable for reasons including at least one of:
the URL is known to contain pornographic or offensive material; or
the URL is associated with a website that is non-business related.

14. An article of manufacture as in claim 9, wherein the instructions to result in a machine altering and disabling the webpage include instructions to animate the altering and disabling of the webpage.

15. An article of manufacture as in claim 9, further including instructions to result in a machine performing operations including
displaying a warning in conjunction with the altering and disabling of the webpage, the warning explaining one or more risks associated with the webpage.

16. An article of manufacture as in claim 9, further including instructions to result in a machine performing operations including
providing an option in conjunction with the altering and disabling of the webpage, the option enabling a user to override the altering and disabling of the webpage.

17. An apparatus for browsing the internet, comprising:
a means for detecting a load request for a webpage in a web browser;
a means for retrieving a Uniform Resource Locator (URL) for the webpage;
a means for displaying the webpage associated with the URL via the web browser;
a means for determining that the URL matches a URL from a list of undesirable URLs; and
a means for altering the appearance of the webpage and disabling the webpage from receiving input or taking action.

18. The apparatus of claim 13, wherein the means for altering the webpage appearance includes a means for at least one of
overlaying the webpage with a graphical element resembling a glass shield; or
overlaying the webpage with graphical elements resembling cobwebs.

19. The apparatus of claim 13, wherein the means for disabling the webpage includes a means for at least one of
disabling script elements of the webpage;
disabling user input fields on the webpage;
disabling plug-in elements of the webpage;
disabling redirect requests initiated by the webpage;
disabling selectable graphical elements of the webpage; or
disabling the further transfer of data between the webpage and the browser.

20. The apparatus of claim 13, wherein the list of undesirable URLs includes URLs determined to be undesirable because the URLs are known or suspected to be phishing websites that mimic a trusted website in order to obtain confidential user information;

21. The apparatus of claim 13, wherein the list of undesirable URLs includes URLs determined to be undesirable for reasons including at least one of:
the URL is known to contain pornographic or offensive material; or
the URL is associated with a website that is non-business related.

22. The apparatus of claim 13, wherein the means for altering and disabling the webpage includes a means for animating the altering and disabling.

23. The apparatus of claim 13, further including a means to display a warning in conjunction with the altering and disabling of the webpage, the warning explaining one or more risks associated with the webpage.

24. The apparatus of claim 13, further including a means to provide an option in conjunction with the altering and disabling of the webpage, the option enabling a user to override the altering and disabling of the webpage.
